(19) United States
(12) Patent Application Publication
(10) Pub. No.: US 2026/0270139 A1
(43) Pub. Date: Sep. 10, 2026

(54) SYSTEM WITH OOB (OUT-OF-BAND) FUNCTION AND REAL-TIME IMAGE TRANSMISSION METHOD

(71) Applicant: AVerMedia TECHNOLOGIES, INC., New Taipei City (TW)

(72) Inventors: Fuping WANG, New Taipei City (TW); Ssu Ming CHENG, New Taipei City (TW); Yen Cheng YAO, New Taipei City (TW)

(21) Appl. No.: 19/558,494

(22) Filed: Mar. 6, 2026

Related U.S. Application Data
(60) Provisional application No. 63/767,592, filed on Mar. 6, 2025.

(51) Int. Cl. H04L 41/08; H04L 65/60; H04N 7/18; H04N 19/156; H04N 19/164

(52) U.S. Cl. CPC H04L 41/08; H04L 65/60; H04N 7/183; H04N 19/156; H04N 19/164

(57) ABSTRACT

A system with an OOB (out-of-band) function includes an OOB management device and a computing system. The OOB management device is communicated with a client device. The computing system is communicated with the OOB management device, the OOB management device is configured to determine an encoding capability of the computing system, wherein the OOB management device is based on the encoding capability to decide to use an in-band path to transmit a real-time image of at least one camera through the computing system or to use an OOB encoder and stream path to transmit the real-time image of the at least one camera through the OOB management device.

### CROSS - REFERENCE TO RELATED APPLICATION

This application claims priority to US Provisional Application Serial Number 63/767,592, filed March 6, 2025, which is herein incorporated by reference in its entirety.

### BACKGROUND

### Field of Invention

The present invention relates to systems and methods, and more particularly, systems with OOB (out-of-band) function and real-time image transmission methods.

### Description of Related Art

Edge artificial intelligence refers to the deployment of artificial intelligence (AI) algorithms and AI models directly on local edge devices such as sensors or Internet of Things (IoT) devices, which enables real-time data processing and analysis without constant reliance on cloud infrastructure.

Edge AI application is maturing, such as AMR (autonomous mobile robot), smart city, smart retail, etc., but there are still some edge cases (e.g., low visibility, noisy environment or unidentified objects) that the edge AI device does not know how to handle, thus human assisted remote monitoring and teleoperation come in to handle these uncertain scenarios to ensure the edge AI devices completing its mission safely. Besides, edge AI devices could work under harsh conditions (e.g., extreme temperature, humidity, etc.), thus introducing OOB (Out-of-band) management to power on/off or reset the devices remotely can ensure the continuous operation without physical intervention. Thus, OOB management with low latency streaming capability to assist edge device performing real time remote system analysis and teleoperation is necessary.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides systems with OOB (out-of-band) function and real-time image transmission methods, to solve or circumvent aforesaid problems and disadvantages in the related art.

An embodiment of the present disclosure is related to a system with an OOB function, and the system includes an OOB management device and a computing system. The OOB management device is communicated with a client device. The computing system is communicated with the OOB management device, the OOB management device is configured to determine an encoding capability of the computing system, wherein the OOB management device is based on the encoding capability to decide to use an in-band path to transmit a real-time image of at least one camera through the computing system or to use an OOB encoder and stream path to transmit the real-time image of the at least one camera through the OOB management device.

Another embodiment of the present disclosure is related to a system with an OOB function, and the system includes at least one camera and an OOB management device. The OOB management device is communicated with a client device, and the OOB management device is configured to receive a real-time image of the at least one camera and to use an OOB encoder and stream path to transmit the real-time image to the client device.

Another embodiment of the present disclosure is related to a system with an OOB function, and the system includes at least one camera and an edge device. The edge device is connected to the at least one camera, the edge device configured to receive a real-time image of the at least one camera, and the edge device configured to use an encoder and stream path to transmit the real-time image to a client device.

Another embodiment of the present disclosure is related to a real-time image transmission method that includes steps of: using an OOB management device to determine an encoding capability of a computing system, wherein the computing system is communicated with the OOB management device, and the OOB management device is communicated with a client device; and using the OOB management device based on the encoding capability to decides to use an in-band path to transmit a real-time image of at least one camera through the computing system or to use an OOB encoder and stream path to transmit the real-time image of the at least one camera through the OOB management device.

Another embodiment of the present disclosure is related to a real-time image transmission method that includes steps of: using an OOB management device to receive a real-time image of at least one camera and to use an OOB encoder and stream path to transmit the real-time image to a client device, wherein the OOB management device is communicated with the client device.

Another embodiment of the present disclosure is related to a real-time image transmission method that includes steps of: using an edge device to receive a real-time image of at least one camera, wherein the edge device is connected to the at least one camera; and using the edge device to use an encoder and stream path to transmit the real-time image to a client device.

In view of the above, the technical solution disclosed in the present disclosure has significant advantages and beneficial effects compared to existing technologies. Unlike traditional OOB solutions that offer only basic remote access, this technology of the present disclosure do an in-band video streaming or an OOB video streaming based on encoding capability (e.g., streaming capability) and edge abnormal condition (e.g., load conditions). It then provides seamless live video feeds for precise diagnostics and full remote control—even when the system is unresponsive.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram of a system with OOB (out-of-band) function according to some embodiments of the present disclosure;

FIG. 2 is a flow chart of a real-time image transmission method according to some embodiments of the present disclosure;

FIG. 3 is a schematic diagram of a user interface according to some embodiments of the present disclosure;

FIG. 4 is a schematic diagram of a user interface according to some embodiments of the present disclosure; and

FIG. 5 is a flow chart of a real-time image transmission method according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

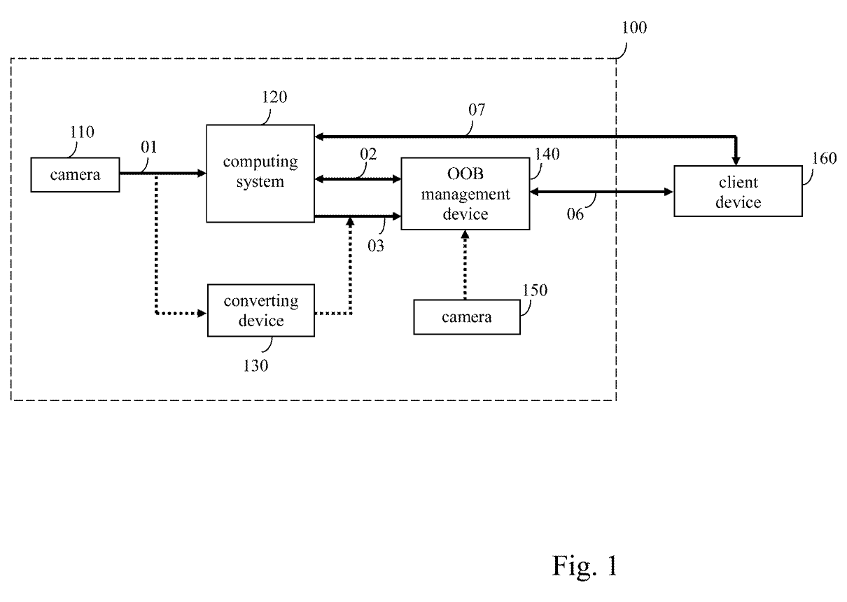

FIG. 1 is a block diagram of a system 100 with OOB (out-of-band) function according to some embodiments of the present disclosure. Referring to FIG. 1, in one aspect, the present disclosure is directed to a system 100. This system 100 may be applicable or readily adaptable to all technologies. Herewith the system 100 is described below with FIG. 1.

The subject disclosure provides the system 100 in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

In the system 100, an object of the present disclosure is to provide an OOB management device 140 with low latency streaming capability to assist a computing system 120 (e.g., a local computer, a cloud computer, an edge device, etc.) of performing live monitoring and full remote control – even when the system 100 is unresponsive. In some embodiments, the system 100 is an electronic system. To facilitate the description of the present disclosure, in some embodiments, the computing system 120 is illustrated as the edge device (e.g., an edge AI device) for an instance, but the present disclosure is not limited thereto.

For example, the computing system 120 (e.g., the edge AI device) can do AI inference according to its multiple inputs, such as video, image, audio and sensor.

In some embodiments, the computing system 120 (e.g., a local computer and/or a cloud computer) can be an edge computing system, such as an edge computing device; it may also be a server, such as a computing server, an edge server or the like. In addition, in some embodiments, the computing system 120 can include AI algorithms or AI models, such as an AI computing system, an edge AI device, an edge AI server or the like. Alternatively, in some embodiments, the computing system 120 may not include AI algorithms or AI models. To facilitate the description of the present disclosure, the present disclosure uses the Edge AI device as an example, but present disclosure is not limited thereto. For example, computing system 120 is the edge AI device, and the edge AI device can be an edge AI hardware (e.g., an edge AI circuit), or another Edge AI hardware (e.g., an edge AI computer) of performing software or the like. In some embodiments, computing system 120 (e.g., the edge device) includes an in-band encoder. For example, the edge device (e.g., the edge AI device) includes an in-band encoder.

At least one camera 110 (e.g., a USB camera, a GMSL camera, a MIPI CSI camera, etc.) is electrically connected to the computing system 120 through interface 01 to capture a real-time image for the computing system 120 to do further processing function (e.g., AI inference). The interface 01 includes one or a combination of a universal serial bus (USB), a gigabit multimedia serial link (GMSL), a mobile industry processor interface – camera serial interface (MIPI CSI), etc. In some embodiments, the system 100 includes at least one camera 150 (e.g., an external camera) which performs the same or like functions of the camera 110 or is used to capture the real-time image of the computing system 120 during operation. In some embodiments, the camera 110 can be omitted, and the camera 150 is electrically connected to the OOB management device 140.

The OOB management device 140 is electrically connected to the computing system 120 with interfaces 02 and 03. For example, the OOB management device 140 can be an OOB hardware (e.g., an OOB circuit or BMC, etc.), another OOB hardware (e.g., an OOB computer or MCU, etc.) of performing software or the like. In some embodiments, the OOB management device 140 includes an OOB encoder. The interface 02 includes one or a combination of a general purpose input/output (GPIO), a universal asynchronous receiver/transmitter (UART), a network, an inter-integrated circuit (I²C), etc., and it is used for communication between the OOB management device 140 and the computing system 120. The computing system 120 (e.g., the edge device) uses at least one interface 02 electrically connected to the OOB management device 140, and transmits the real-time image to the client device 160 through a encoder and stream path. For example, aforesaid encoder and stream path can be an OOB encoder and stream path.

The video interface 03 includes one of a high-definition multimedia interface (HDMI), a video graphics array (VGA), a DisplayPort (DP), a USB type-C, etc., and it used to transmit video from the computing system 120 to the OOB management device 140. In some embodiments, the computing system 120 (e.g., the edge device) uses the video interface 03 to transmit the real-time image to the client device 160 through the OOB encoder and stream path.

In some embodiments, the OOB management device 140 can use interface 02 (e.g., the GPIO) to power on/off, to reset and to perform a force shutdown on the computing system 120 (e.g., the Edge AI device), and it can communicate with the computing system 120 (e.g., the edge device) through UART, network, and I2C, etc. to control or handle the information/action (power status, processor status, thermal sensor, fan control, start streaming video, stop streaming video, etc.) of the computing system 120 (e.g., the edge device).

In some embodiments, the OOB management device 140 serves as a Redfish API server, it provides a Redfish API service through network connection 06 to a Redfish application programming interface (API) of the client device 160 located at remote site for doing OOB management tasks.

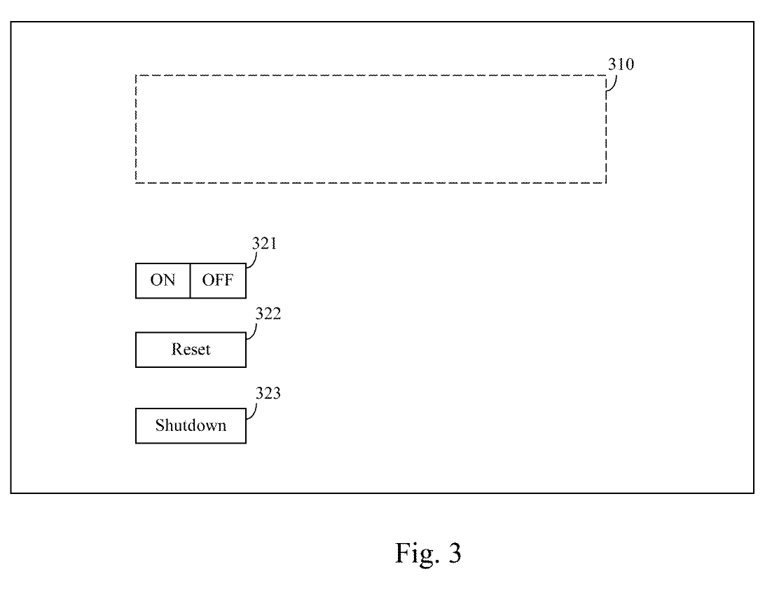

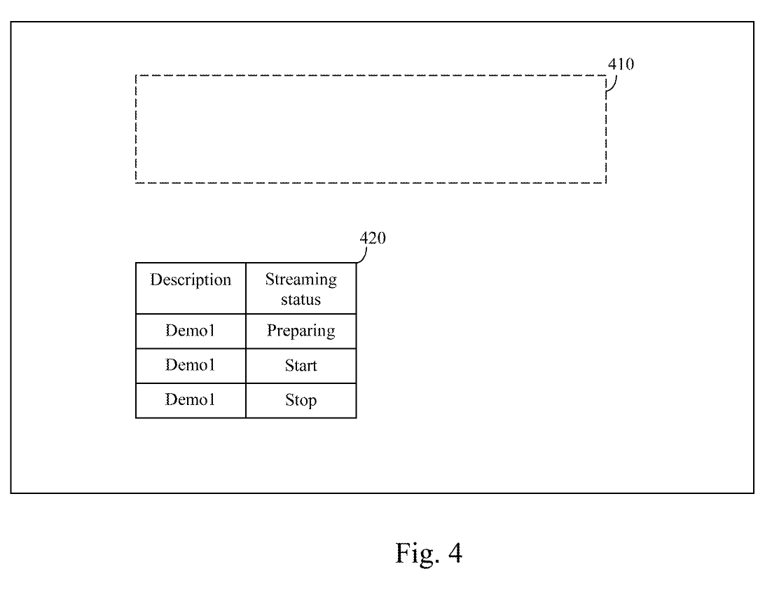

An application on a remote web browser can be executed by the client device 160, this application can includes two parts, one part including Redfish service related UI as shown in FIG. 3 which display system information 310 (e.g., a device name, a IP address, a power status, etc.) of the computing system 120 and some action buttons (e.g., an on/off button 321, a reset button 322, a force shutdown button 323), another part as shown in FIG. 4) including stream settings 410 and streaming related application 420 (e.g., WebRTC), the user can decide to start/stop an edge streaming (in-band streaming) or an OOB streaming for their need. For example, the client device 160 can be used for executing the application, and the client device 160 can be an electronic hardware (e.g., a smart phone, a tablet, a laptop, a personal computer, etc.) or the like.

In some embodiments, additional components can be added to the system 100 to fulfill the OOB streaming. A converting device 130 is used to select a video path to specific cameras and its subsequent transmission interface conversion, and the camera 150 (e.g., the external camera) is used to capture the real-time image of the computing system 120 (e.g., the edge device) during operation. For example, the converting device 130 can be a splitter/switcher and converter, and the converting device 130 can be a converting hardware (e.g., a converting circuit), another converting hardware (e.g., a converting computer) of performing software, or the like.

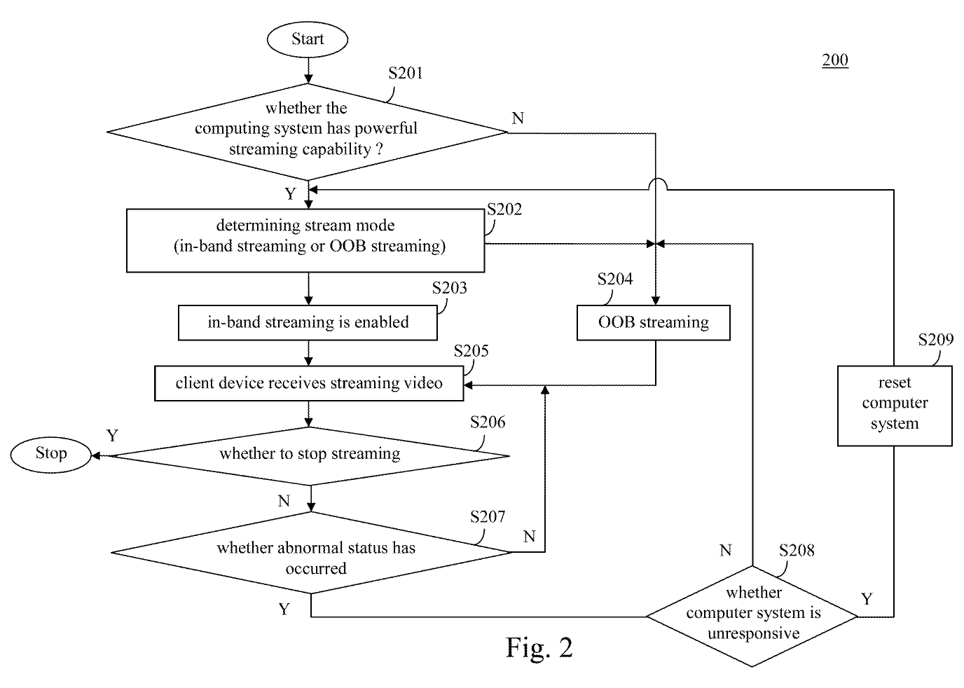

For a more complete understanding of a real-time image transmission method 200 of the system 100, refer to FIG. 1 and FIG. 2. FIG. 2 is a flow chart of the real-time image transmission method 200 according to some embodiments of the present disclosure. As shown in FIG. 2, the real-time image transmission method 200 includes steps S201-S209. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

The real-time image transmission method 200 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

First of all, the streaming function of the system 100 is activated. In step S201, whether the computing system 120 (e.g., an edge device) has powerful streaming capability is checked. In some embodiments, the powerful streaming capability, including an encoding capability, can meet the streaming conditions, and the loading status of the computing system 120 is not heavy (under a certain threshold). For example, the OOB management device 140 checks whether the encoding capability of the computing system 120 can meet the streaming conditions (e.g., predetermined resolution and frame rate), and then conducts a preliminary streaming test to check the status of CPU/GPU usage, network usage, memory usage, temperature, etc. of the computing system 120. Due to this extra streaming workload, if the aforementioned loading status is still under the certain threshold, the system 100 can afford to do the in-band streaming through the in-band encoder, otherwise the OOB streaming through an OOB encoder.

In some embodiments, the OOB management device 140 is communicated with the client device 160, and the computing system 120 is communicated with the OOB management device 140. In step S201, the OOB management device 140 is configured to determine the encoding capability of the computing system 120. In step S202, the OOB management device 140 is based on the encoding capability to decide to use an in-band path (e.g., a path of the in-band streaming through the in-band encoder) to transmit a real-time image of at least one camera 110 through the computing system 120 or to use an OOB encoder and stream path (e.g., a path of the OOB streaming through the OOB encoder) to transmit the real-time image of the at least one camera 110 through the OOB management device 140.

Additionally or alternatively, in step S202, the stream mode is determined; for example, whether the in-band streaming or the OOB streaming is activated is determined. In some embodiments, the default setting uses the in-band streaming or the OOB streaming, or the in-band streaming or the OOB streaming is activated based on the received command. For example, the user can use the client device 160 to check the evaluation report conducted in the last step to activate the in-band streaming or the OOB streaming. In some embodiments, if the OOB management device 140 failed to get the in-band streaming evaluation report within a specific timeout period or skip the step S201 mentioned process completely (use default setting for quicker operation flow), the user can use the client device 160 to activate a default streaming scenario setting (i.e., a default OOB streaming path). Thus, in some embodiments, the system 100 can have a default streaming scenario setting (i.e., a default OOB streaming path) for quicker operation workflow. In some embodiments, the computing system 120 can set the default OOB streaming path. In some embodiments, the computing system 120 may configure, store, or update a default streaming path setting.

In some embodiments, the order of steps S201 and S202 can be interchanged. When the computing system 120 (e.g., the edge device) doesn’t have powerful streaming capability, the system 100 needs to do the OOB streaming instead of doing the in-band streaming.

In step S203, the in-band streaming is enabled or activated. In a case of the in-band streaming, the data flow is described as follows. The computing system 120 (e.g., the edge device) receives the input of selected at least one camera 110 and generates the video feed through the in-band encoder, and sends the video through the network connection 07 to the remote streaming application of the client device 160 directly; control command from the client device 160 can be sent back to the computing system 120 (e.g., the edge device) for faster response or via Redfish API command from the OOB management device 140 indirectly. In some embodiments, control commands associated with teleoperation may be transmitted through the same communication path used for streaming. In other embodiments, control commands may be transmitted through an available communication interface of the system 100.

In some embodiments, in step S203, the computing system 120 (e.g., the edge device) is electrically connected to the at least one camera 110, the computing system 120 (e.g., the edge device) is configured to receive a real-time image of the at least one camera 110, and the computing system 120 (e.g., the edge device) is configured to use an encoder and stream path to transmit the real-time image to the client device 160. Specifically, in one embodiment, the encoder and stream path is the in-band path, and the computing system 120 (e.g., the edge device) transmits the real-time image to the client device 160 through the in-band path.

In step S204, the OOB streaming is activated. In a case of the OOB streaming, the data flow is described as follows. The input data (or video) from at least one camera 110 or 150 is fed into the OOB management device 140, the generated video fed by the OOB management device 140 through its OOB encoder is sent to the remote streaming application of the client device 160 through the network connection 06.

The one objective of the present disclosure is the OOB management device 140 with streaming capability to assist the computing system 120 (e.g., the edge device) for performing real time remote system analysis and teleoperation.

In some embodiments, in another case of the OOB streaming, the data flow described as follows. The input data of at least selected one camera 110 is fed into the converting device 130 and then flows into the OOB management device 140, the generated video feed by the OOB management device 140 through its OOB encoder is sent to the remote streaming application of the client device 160 through the network connection 06.

In some embodiments, in yet another case of the OOB streaming, the data flow described as follows. The camera 150 is electrically connected to the OOB management device 140, the input data of the camera 150 is fed into the OOB management device 140, and the generated video fed by the OOB management device 140 through its OOB encoder is sent to the remote streaming application of the client device 160 through the network connection 06.

In view of the above, as to one or more OOB streaming paths, in some embodiments, the OOB management device 140 is communicated with the client device 160, and the OOB management device 140 is configured to receive a real-time image of the at least one camera 110 or 150 and to use the OOB encoder and stream path to transmit the real-time image to the client device 160.

Specifically, in one embodiment, the at least one camera 110 is physically connected to the computing system 120 (e.g., the edge device), the computing system 120 (e.g., the edge device) transmits the real-time image from the at least one camera 110 to the OOB management device 140, and the OOB management device 140 transmits the real-time image to the client device 160 through the OOB encoder and stream path.

Specifically, in another embodiment, the at least one camera 110 is electrically connected to the OOB management device 140 through the converting device 130, the converting device 130 transmits the real-time image from the at least one camera 110 to the OOB management device 140, and the OOB management device 140 transmits the real-time image to the client device 160 through the OOB encoder and stream path.

Specifically, in yet another embodiment, the at least one camera 150 is physically connected to the OOB management device 140, and the OOB management device 140 transmits the real-time image to the client device 160 through the OOB encoder and stream path.

In step S205, the client device 160 receives the streaming video (e.g., the real-time image). For example, the remote user can use the client device 160 to receive streaming video for live monitoring and teleoperation, the user can not only get streaming status but also can perform the OOB management task. Observing the system status such as CPU/GPU usage, temperature sensor readings, network usage would help the user to realize if the system 100 could keep the streaming task smoothly or need to take appropriate action to prevent system disastrous situation from happening. In some embodiments, the teleoperation may include transmitting control commands from the client device 160 to the computing system 120 for remotely controlling operation of the computing system 120 or an associated device. The transmission of such control commands may be performed through the same communication path used for streaming or through one of the communication interfaces described herein.

In step S206, whether to stop streaming is determined. Once the OOB management device 140 or the computing system 120 (e.g., the edge device) receives a stop streaming command from the client device 160, the streaming task is stopped.

In step S207, whether an abnormal status has occurred is checked. The abnormal status occurred such as CPU/GPU usage higher than certain threshold, network usage too heavy or unstable, too high or too low temperature readings, streaming video frame rate dropping a lot or video freeze, the computing system 120 (e.g., the edge device) with heavy loading, or the computing system 120 (e.g., the edge device) being unresponsive. If an abnormal status occurs, step S208 is executed. If no abnormal status occurs, step S205 is executed.

In some embodiments, the client device 160 or the OOB management device 140 decides whether to switch the OOB encoder and stream path or reset the edge device based on at least one edge abnormal condition (e.g., above abnormal status) of the computing system 120 (e.g., the edge device).

In step S208, whether the computing system 120 (e.g., the edge device) is unresponsive is determined. If the computing system 120 (e.g., the edge device) is unresponsive, step S209 is executed. If the computing system 120 (e.g., the edge device) is going to be unresponsive, it can take corresponding action for recovery of the system 100. For the in-band streaming scenario, it can switch to the OOB streaming to lower the workload of the computing system 120 (e.g., the edge device) to make it recover to its normal working status. For the OOB or in-band streaming scenario, it can control the computing system 120 (e.g., the edge device) to move to a safe location and try to recover the system 100. In some embodiments, the remote user can use the client device 160 to send the control command to remotely control the computing system 120 (e.g., the edge device) to switch to the OOB streaming, to move to a safe location or to try to recover the system 100 or to perform another corresponding action for recovery of the system 100.

In step S209, the computing system 120 (e.g., the edge device) is reset. If there is no safety concern, one can reset the computing system 120 (e.g., the edge device) for recovery purpose immediately, otherwise one need to take the step S208 mentioned appropriate action then reset or undergo power off/on process to recover the system 100.

FIG. 3 is a schematic diagram of a user interface (UI) according to some embodiments of the present disclosure. In some embodiments, the on/off button 321, the reset button 322, the force shutdown button 323 (such as virtual keys, UI icons, or physical buttons, etc.) can be used to generate corresponding control signals. For example, the user can select the on/off button 321 to power on/off the system and observe its corresponding status through the UI, and the user can select the reset button 322 to reset the system 100 or select the force shutdown button 323 to shut down the system 100.

FIG. 4 is a schematic diagram of a user interface (UI) according to some embodiments of the present disclosure. In some embodiments, there may be multiple systems 100, in which one Demo1 refers to one system. For example, the status of the system 100 (Preparing) can be displayed on the UI, and the user can control whether to start streaming (Start/Stop) through the UI when the user views the real-time image through the window (whether there is any frame drop or freezing).

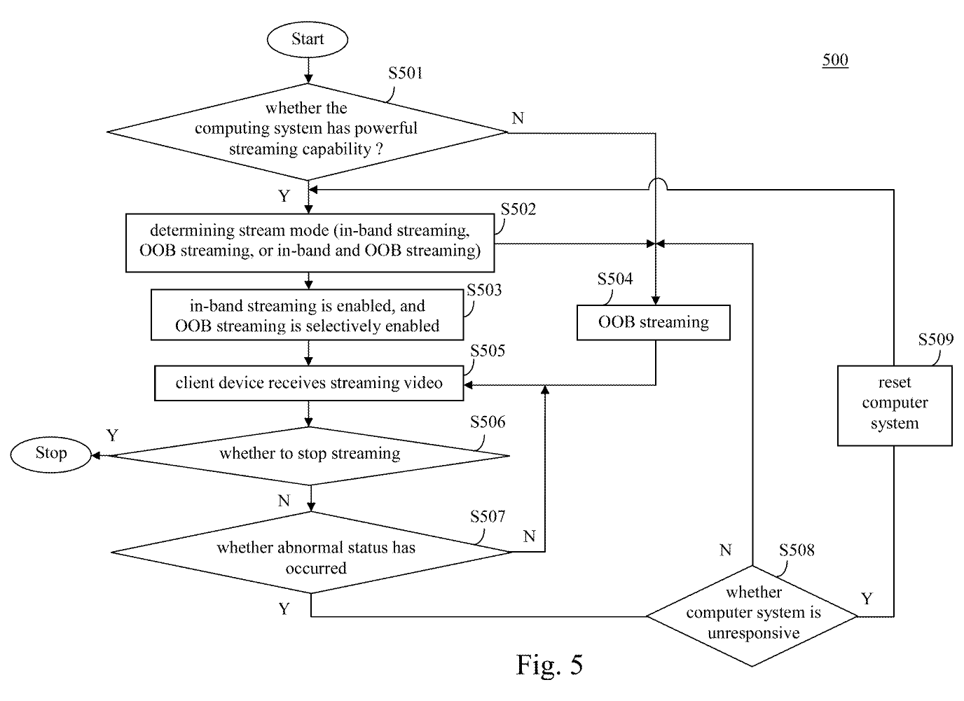

For a more complete understanding of a real-time image transmission method 500 of the system 100, refer to FIG. 1 to FIG. 5. FIG. 5 is a flow chart of the real-time image transmission method 500 according to some embodiments of the present disclosure. As shown in FIG. 5, the real-time image transmission method 500 includes steps S501-S509. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

In some embodiments, steps S501 and S504 to S509 are substantially the same as steps S201 and S204 to S209, and thus the details of steps S501 and S504 to S509 are not repeated herein.

In step S502, the stream mode is determined; for example, whether the in-band streaming, the OOB streaming or the in-band and OOB streaming is activated is determined on a basis of encoding capability of the computing system 120 or the default setting from the client device 160. In some embodiments, the in-band and OOB streaming can include both of the in-band streaming and the OOB streaming.

In step S503, the in-band streaming is enabled or activated, and the OOB streaming is selectively enabled or activated. In some embodiments, the in-band streaming and the OOB streaming can be activated synchronously; or, the in-band streaming is activated and the OOB streaming is enabled for a backup.

In view of the above, the technical solution disclosed in the present disclosure has significant advantages and beneficial effects compared to existing technologies. Unlike traditional OOB solutions that offer only basic remote access, this technology of the present disclosure do an in-band video streaming or an OOB video streaming based on encoding capability (e.g., streaming capability) and edge abnormal condition (e.g., load conditions). It then provides seamless live video feeds for precise diagnostics and full remote control—even when the system is unresponsive.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A system with an OOB (out-of-band) function, comprising:
an OOB management device communicated with a client device; and
a computing system communicated with the OOB management device, and the OOB management device configured to determine an encoding capability of the computing system, wherein the OOB management device is based on the encoding capability to decide to use an in-band path to transmit a real-time image of at least one camera through the computing system or to use an OOB encoder and stream path to transmit the real-time image of the at least one camera through the OOB management device.

2. The system with the OOB function of claim 1, wherein the computing system is an edge device.

3. The system with the OOB function of claim 2, wherein the client device or the OOB management device decides whether to switch the OOB encoder and stream path or reset the edge device based on at least one edge abnormal condition of the edge device.

4. The system with the OOB function of claim 2, wherein the at least one camera is physically connected to the edge device, the edge device transmits the real-time image from the at least one camera to the OOB management device, and the OOB management device transmits the real-time image to the client device through the OOB encoder and stream path.

5. The system with the OOB function of claim 1, wherein the at least one camera is electrically connected to the OOB management device through a converting device, the converting device transmits the real-time image from the at least one camera to the OOB management device, and the OOB management device transmits the real-time image to the client device through the OOB encoder and stream path.

6. The system with the OOB function of claim 1, wherein the at least one camera is physically connected to the OOB management device, and the OOB management device transmits the real-time image from the at least one camera to the client device through the OOB encoder and stream path.

7. The system with the OOB function of claim 1, wherein the computing system sets a default OOB streaming path.

8. A system with an OOB (out-of-band) function, comprising:
at least one camera; and
an OOB management device communicated with a client device, and the OOB management device configured to receive a real-time image of the at least one camera and to use an OOB encoder and stream path to transmit the real-time image to the client device.

9. A system with an OOB (out-of-band) function, comprising:
at least one camera; and
an edge device electrically connected to the at least one camera, the edge device configured to receive a real-time image of the at least one camera, and the edge device configured to use an encoder and stream path to transmit the real-time image to a client device.

10. The system with the OOB function of claim 9, wherein the edge device uses at least one interface electrically connected to an OOB management device, and transmits the real-time image to the client device through the encoder and stream path, wherein the at least one interface is a general purpose input/output (GPIO), a universal asynchronous receiver/transmitter (UART), a network or an inter-integrated circuit (I²C).

11. The system with the OOB function of claim 9, wherein the edge device uses a video interface to transmit the real-time image to the client device through the encoder and stream path, and the encoder and stream path is an OOB encoder and stream path.

12. The system with the OOB function of claim 9, wherein the edge device transmits the real-time image to the client device through an in-band path, and the encoder and stream path is the in-band path.

13. A real-time image transmission method, comprising:
using an OOB (out-of-band) management device to determine an encoding capability of a computing system, wherein the computing system is communicated with the OOB management device, and the OOB management device is communicated with a client device; and
using the OOB management device based on the encoding capability to decides to use an in-band path to transmit a real-time image of at least one camera through the computing system or to use an OOB encoder and stream path to transmit the real-time image of the at least one camera through the OOB management device.

14. The real-time image transmission method of claim 13, wherein the computing system is an edge device.

15. The real-time image transmission method of claim 14, further comprising:
using the client device or the OOB management device to decide whether to switch the OOB encoder and stream path or reset the edge device based on at least one edge abnormal condition of the edge device.

16. The real-time image transmission method of claim 14, wherein the at least one camera is physically connected to the edge device, the edge device transmits the real-time image from the at least one camera to the OOB management device, and the OOB management device transmits the real-time image to the client device through the OOB encoder and stream path.

17. The real-time image transmission method of claim 13, wherein the at least one camera is electrically connected to the OOB management device through a converting device, the converting device transmits the real-time image from the at least one camera to the OOB management device, and the OOB management device transmits the real-time image to the client device through the OOB encoder and stream path.

18. The real-time image transmission method of claim 13, wherein the at least one camera is physically connected to the OOB management device, and the OOB management device transmits the real-time image from the at least one camera to the client device through the OOB encoder and stream path.

19. The real-time image transmission method of claim 13, wherein the computing system sets a default OOB streaming path.

20. A real-time image transmission method, comprising:
using an OOB (out-of-band) management device to receive a real-time image of at least one camera and to use an OOB encoder and stream path to transmit the real-time image to a client device, wherein the OOB management device is communicated with the client device.

21. A real-time image transmission method, comprising:
using an edge device to receive a real-time image of at least one camera, wherein the edge device is connected to the at least one camera; and
using the edge device to use an encoder and stream path to transmit the real-time image to a client device.

22. The real-time image transmission method of claim 21, wherein the edge device uses an interface connected to an OOB management device, and to transmit the real-time image to the client device through the encoder and stream path, wherein the interface is a general purpose input/output (GPIO), a universal asynchronous receiver/transmitter (UART), a network or an inter-integrated circuit (I²C).

23. The real-time image transmission method of claim 21, wherein the edge device uses a video interface to transmit the real-time image to the client device through the encoder and stream path, and the encoder and stream path is an OOB encoder and stream path.

24. The real-time image transmission method of claim 21, wherein the edge device transmits the real-time image to the client device through an in-band path, and the encoder and stream path is the in-band path.
